(19) United States
(12) Patent Application Publication
(10) Pub. No.: US 2018/0017052 A1
(43) Pub. Date: Jan. 18, 2018

(54) ABNORMAL DISCHARGE DETECTION DEVICE AND ABNORMAL DISCHARGE DETECTION METHOD

(71) Applicant: JTEKT CORPORATION, Osaka (JP)

(72) Inventors: Masami NAKA, Yamatokoriyama-shi (JP); Yoshimichi HIGASHIYAMA, Kashihara-shi (JP); Tsukasa SAKAZAKI, Kizugawa-shi (JP)

(73) Assignee: JTEKT CORPORATION, Osaka (JP)

(21) Appl. No.: 15/641,574

(22) Filed: Jul. 5, 2017

(30) Foreign Application Priority Data
Jul. 12, 2016 (JP) 2016-137881

(51) Int. Cl. F04B 51/00; F16C 33/66

(52) U.S. Cl. CPC F04B 51/00; F16C 33/6659; F16C 2233/00

(57) ABSTRACT

A pump included in an oil supply unit includes a piezoelectric body that is repeatedly deformed when a pulsed drive voltage is applied from a drive unit. The pump discharges lubricant as the volume of a storage unit that stores fluid to be supplied decreases with deformation of the piezoelectric body. An abnormal discharge detection device that detects an abnormal fluid discharge operation of the pump includes: a measurement unit that measures a terminal voltage of the piezoelectric body; and a control unit functioning as a determination unit that determines if the discharge operation is being performed normally or not based on whether or not the measured terminal voltage has changed with time during application of a pulse of the drive voltage.

### INCORPORATION BY REFERENCE

The disclosure of Japanese Patent Application No. 2016-137881 filed on Jul. 12, 2016 including the specification, drawings and abstract, is incorporated herein by reference in its entirety.

### BACKGROUND OF THE INVENTION

### 1. Field of the Invention

The present invention relates to abnormal discharge detection devices and abnormal discharge detection methods, and more particularly to devices and methods for detecting an abnormal fluid discharge operation in a fluid supply device using a piezoelectric element.

### 2. Description of the Related Art

Pumps using a piezoelectric element as an actuator are known in the art. Such pumps are also called diaphragm pumps. Since these pumps can discharge a very small amount of fluid, these pumps are used for fluid supply devices that are required to supply fluid with reduced frequency.

For example, Japanese Patent Application Publication No. 2004-108388 (JP 2004-108388 A) and Japanese Patent Application Publication No. 2012-102803 (JP 2012-102803 A) disclose a fluid supply device using such a pump, specifically an oil supply device (oil supply unit) integral with a rolling bearing.

If there is an abnormality in the pump mounted on the fluid supply device, fluid may not be discharged from the pump. In particular, in the case where the fluid supply device is an oil supply unit mounted integrally with a rolling bearing, an abnormality may occur in the pump due to vibration etc., which may result in poor lubrication of the rolling bearing.

### SUMMARY OF THE INVENTION

It is one object of the present invention to provide an abnormal discharge detection device and an abnormal discharge detection method which can accurately detect an abnormal fluid discharge operation in a fluid supply device.

According to an aspect of the present invention, an abnormal discharge detection device detects an abnormal fluid discharge operation in a fluid supply device, the fluid supply device including a drive unit that outputs a pulsed drive voltage, a piezoelectric element that is repeatedly deformed when the pulsed drive voltage is applied, and a storage unit that stores therein fluid to be supplied, and the fluid supply device discharging the fluid from the storage unit as volume of the storage unit decreases with the deformation of the piezoelectric element. The abnormal discharge detection device includes: a measurement unit that measures a terminal voltage of the piezoelectric element; and a determination unit that determines if the discharge operation is being performed normally or not based on whether or not the terminal voltage measured with the measurement unit has changed with time during application of a pulse of the drive voltage.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view of a bearing device according to an embodiment, taken along a plane including a central axis of a shaft;

FIG. 2 is a sectional view of the bearing device taken along line A-A in FIG. 1;

FIG. 3 is a schematic view illustrating the configuration of a pump included in the bearing device;

FIG. 4 is a block diagram showing the configuration of an abnormal discharge detection device;

FIG. 5 is a waveform chart schematically showing a waveform of a terminal voltage during application of a pulse of drive voltage in the case where a piezoelectric element cannot be driven;

FIG. 6 is a waveform chart schematically showing a waveform of the terminal voltage during application of a pulse of drive voltage in the case where the piezoelectric element is operating normally;

FIG. 7 is a waveform chart showing the relationship between the terminal voltage and threshold voltages that are used for detecting an abnormality, in the case where a discharge operation is being performed normally;

FIG. 8 is a waveform chart showing the relationship between the terminal voltage and the threshold voltages that are used for detecting an abnormality, in the case where a discharge operation is being performed abnormally; and

FIG. 9 is a flowchart illustrating a detection operation of an abnormal discharge detection device.

### DETAILED DESCRIPTION OF EMBODIMENTS

A preferred embodiment will be described with reference to the accompanying drawings. In the following description, the same components and constituent elements are denoted with the same reference characters. Such components and constituent elements have the same names and functions. Accordingly, description thereof will not be repeated.

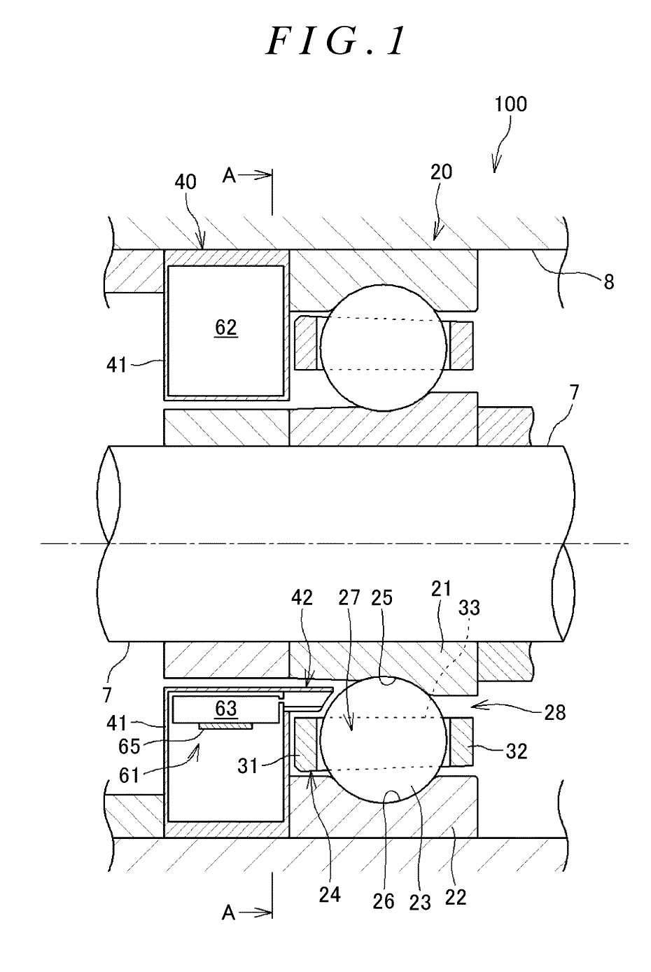

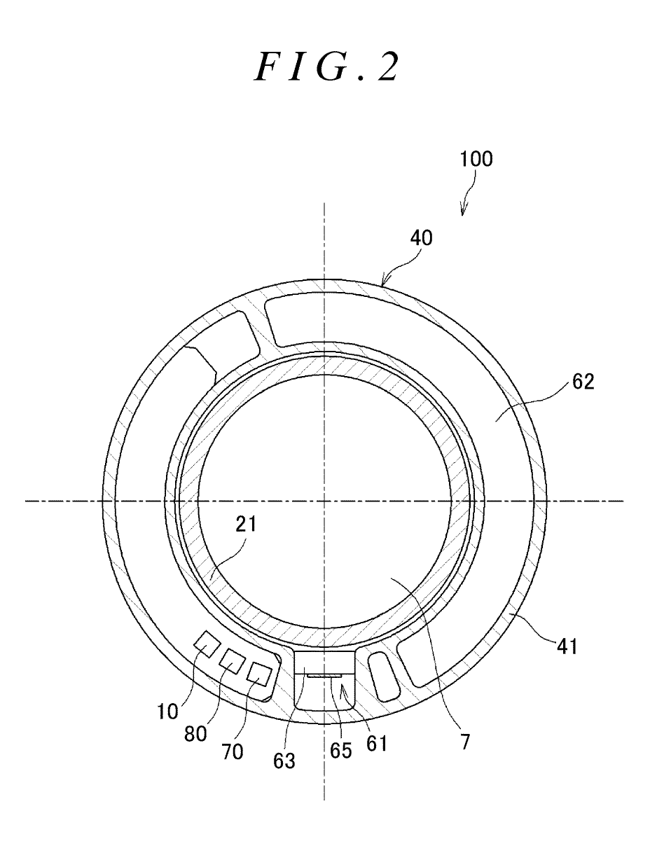

FIG. 1 is a sectional view of a bearing device 100 equipped with an abnormal discharge detection device according to the present embodiment, taken along a plane including a central axis of a shaft. FIG. 2 is a sectional view of the bearing device 100 taken along line A-A in FIG. 1. Referring to FIGS. 1 and 2, the bearing device 100 includes a power supply unit 10, a bearing body 20, an oil supply unit 40 that is an example of a fluid supply device, a drive unit 70, and a control unit 80. The bearing device 100 is accommodated in a bearing housing 8 in order to rotatably support, e.g., a spindle (shaft 7) of a machine tool.

The bearing body 20 has an inner ring 21, an outer ring 22, a plurality of rolling elements (balls) 23, and an annular cage 24. The cage 24 holds the plurality of rolling elements 23. The inner ring 21 is a cylindrical member that is fitted on the shaft 7. The inner ring 21 has a raceway groove (hereinafter referred to as the inner ring raceway groove 25) in its outer periphery. The outer ring 22 is a cylindrical member that is fixed to an inner peripheral surface of the bearing housing 8. The outer ring 22 has a raceway groove (hereinafter referred to as the outer ring raceway groove 26) in its inner periphery. The inner ring 21 and the outer ring 22 are concentrically disposed with an annular space 28 therebetween. In the present embodiment, the inner ring 21 rotates with the shaft 7 relative to the outer ring 22. The plurality of rolling elements 23 are arranged in the annular space 28 between the inner ring 21 and the outer ring 22 and roll in the inner ring raceway groove 25 and the outer ring raceway groove 26.

The cage 24 is disposed in the annular space 28. The cage 24 is an annular member. The cage 24 has a plurality of pockets 27 formed at regular intervals in the circumferential direction in order to hold the plurality of rolling elements 23. The cage 24 has a plurality of annular portions 31, 32 and a plurality of cage bars 33. The pair of annular portions 31, 32 are located on both sides in the axial direction of the rolling elements 23. The cage bars 33 connect the annular portions 31, 32 to each other. The plurality of cage bars 33 are formed at intervals in the circumferential direction. The pockets 27 are regions each surrounded by the annular portions 31, 32 and two of the cage bars 33 which are adjacent to each other in the circumferential direction. A single rolling element 23 is accommodated in each pocket 27, so that the cage 24 can hold the plurality of rolling elements 23 side by side in the circumferential direction.

The oil supply unit 40 serving as a fluid supply device is disposed next to the annular space 28 of the bearing body 20. Specifically, the oil supply unit 40 is disposed on one side in the axial direction of the annular space 28 of the bearing body 20. The oil supply unit 40 can supply lubricant (oil) to the annular space 28. Lubricant (oil) is one example of fluid. The oil supply unit 40 has a case 41 and a nozzle 42. The nozzle 42 extends in the axial direction from the case 41.

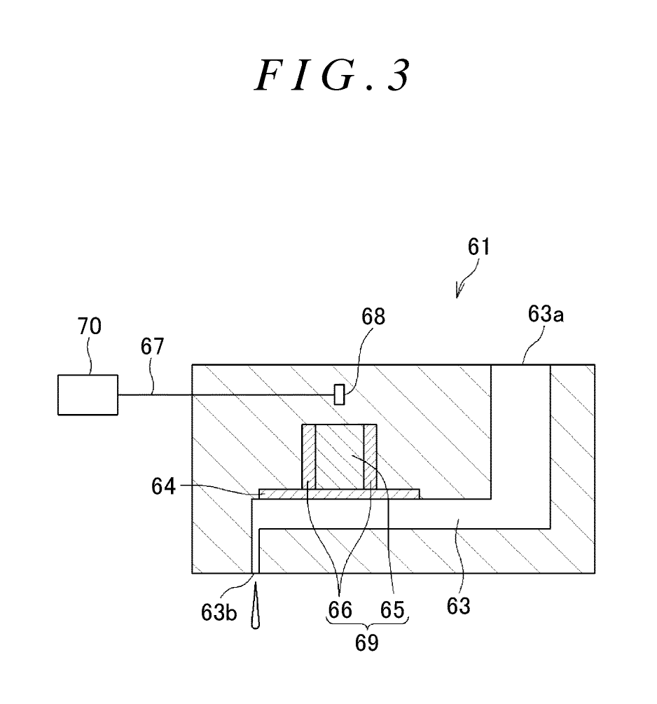

A tank 62 and a pump 61 are disposed in the space inside the case 41 of the oil supply unit 40. The tank 62 stores lubricant therein. The pump 61 can store lubricant therein. The pump 61 has a pressure chamber 63, a diaphragm (vibrating plate) 64 (FIG. 3), and a piezoelectric body 65. The pump 61 supplies lubricant stored in the pressure chamber 63. The diaphragm 64 is disposed so as to face the pressure chamber 63. The piezoelectric body 65 is disposed on the back side of the pressure chamber 63 so as to be in contact with the diaphragm 64. The piezoelectric body 65 is deformed when a voltage is applied. The diaphragm 64 disposed in contact with the piezoelectric body 65 is deformed with the deformation of the piezoelectric body 65. The volume of the pressure chamber 63 of the pump 61 decreases with the deformation of the diaphragm 64. That is, the diaphragm 64 transmits the deformation of the piezoelectric body 65 to the pressure chamber 63.

When the volume of the pressure chamber 63 decreases, a small amount of lubricant is discharged from the pressure chamber 63 into the annular space 28 through the nozzle 42 accordingly. Lubricant is discharged from the pressure chamber 63 and supplied to the annular space 28 at a very low flow rate that is lower than, e.g., picoliter flow rates. When the volume of the pressure chamber 63 increases, the pump 61 sucks lubricant from the tank 62 accordingly and supplies the lubricant into the pressure chamber 63.

Referring to FIG. 2, the power supply unit 10, the drive unit 70, and the control unit 80 are disposed in the space in the case 41. The drive unit 70 drives the pump 61 mounted in the oil supply unit 40. The control unit 80 is connected to the drive unit 70 and controls driving of the pump 61 by the drive unit 70. The oil supply unit 40 thus performs an oil supply operation as controlled by the control unit 80. The power supply unit 10 includes a battery, not shown, and supplies electric power to the control unit 80.

FIG. 3 is a schematic view illustrating the configuration of the pump 61. The pump 61 is a diaphragm pump. Specifically, the pressure chamber 63 of the pump 61 has a suction port 63a and a discharge port 63b. The suction port 63a extends to the tank 62, and the discharge port 63b communicates with the nozzle 42. The pump 61 includes the diaphragm 64, the piezoelectric body 65, and a pair of electrodes 66. The diaphragm 64 is disposed so as to face the pressure chamber 63. The piezoelectric body 65 is disposed on the back side of the pressure chamber 63 so as to be in contact with the diaphragm 64. The pair of electrodes 66 supply a voltage to the piezoelectric body 65. The piezoelectric body 65 and the electrodes 66 form a piezoelectric element 69.

The drive unit 70 is connected to a terminal 68 of the piezoelectric element 69 by a power line 67. The drive unit 70 outputs a constant pulsed drive voltage to the terminal 68 via the power line 67. The terminal 68 is connected to the electrodes 66. The piezoelectric body 65 is, e.g., a piezo element, and is deformed when a drive voltage is applied to the electrodes 66.

When the drive unit 70 applies a drive voltage to the electrodes 66, the piezoelectric body 65 is deformed (extended) to press the diaphragm 64 toward the pressure chamber 63. The diaphragm 64 thus presses the pressure chamber 63, whereby the volume of the pressure chamber 63 decreases accordingly. A small amount of lubricant is thus discharged from the pressure chamber 63 into the annular space 28 through the nozzle 42. This operation is also referred to as a discharge operation.

When the drive unit 70 stops applying the drive voltage to the electrodes 66 and the drive voltage applied to the electrodes 66 is reduced, the piezoelectric body 65 that has been extended contracts and returns to its original position and thus stops pressing the diaphragm 64. Since the piezoelectric body 65 stops pressing the diaphragm 64, the volume of the pressure chamber 63 returns to its original volume, so that lubricant is introduced from the tank 62 into the pressure chamber 63. That is, the pump 61 sucks lubricant from the tank 62. This operation is also referred to as a suction operation.

Since the drive unit 70 applies a constant pulsed drive voltage to the piezoelectric element 69, the pump 61 alternately repeats suction and discharging operations. An operation of supplying lubricant from the oil supply unit 40 to the bearing body 20 (oil supply operation) is thus repeated.

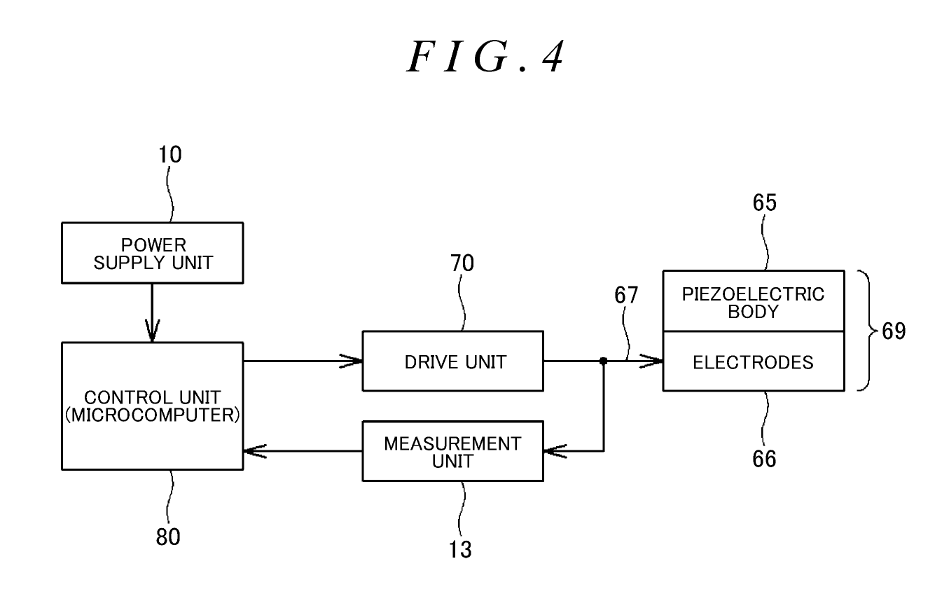

The control unit 80 also functions as an abnormal discharge detection device that detects an abnormal discharge operation in the oil supply unit 40. FIG. 4 is a block diagram showing the configuration of the abnormal discharge detection device. Referring to FIG. 4, the abnormal discharge detection device includes a measurement unit 13 in addition to the control unit 80. The measurement unit 13 is connected to the power line 67 connecting the drive unit 70 and the electrodes 66, and measures a voltage (terminal voltage) between the pair of electrodes 66. The measurement unit 13 includes a converter, not shown, etc. The measurement unit 13 steps down the measured voltage (terminal voltage) to a voltage suitable for the control unit 80 and applies this voltage to the control unit 80. The control unit 80 includes a microcomputer etc. The control unit 80 functions as a determination unit that determines if a discharge operation is being performed normally or not based on whether or not the measured terminal voltage has changed with time during application of a drive voltage.

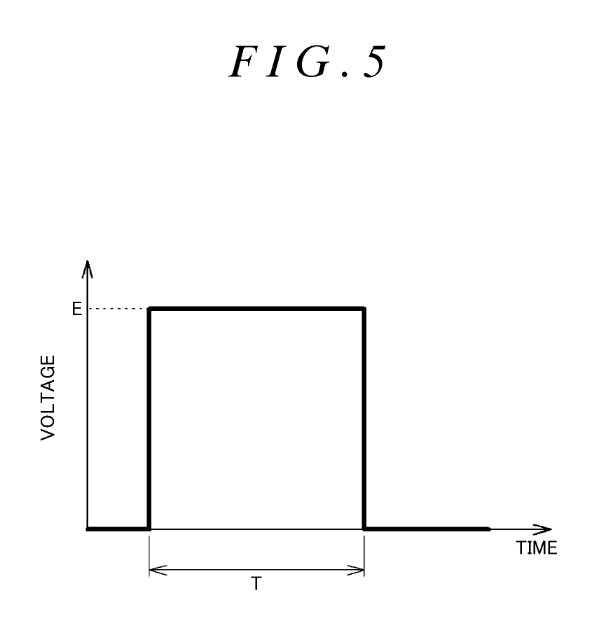

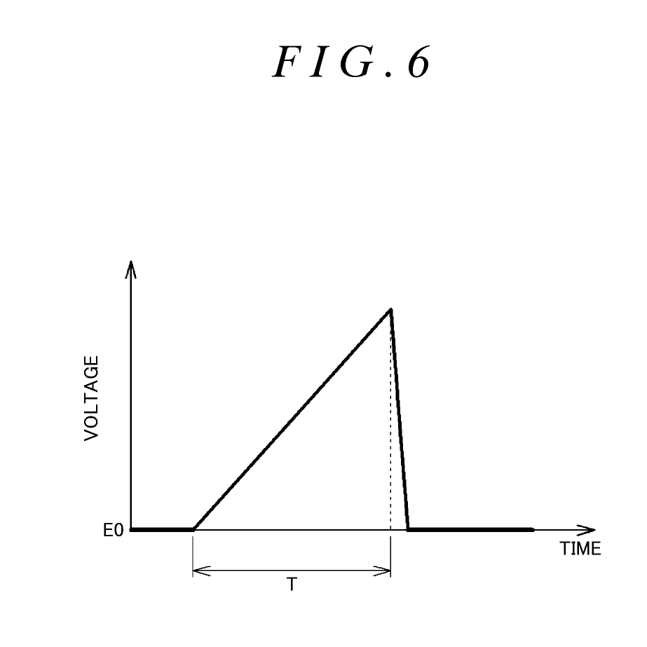

The principle of detecting an abnormality in the oil supply unit 40 by the detection device will be described with reference to FIGS. 5 and 6. FIG. 5 is a waveform chart schematically showing a waveform of the terminal voltage during application T of a pulse of drive voltage, namely an output waveform of the drive unit 70, in the case where the piezoelectric element 69 cannot be driven due to failure etc. of the piezoelectric element 69. FIG. 6 is a waveform chart schematically showing a waveform of the terminal voltage during application T of a pulse of drive voltage in the case where the piezoelectric element 69 is operating normally. Referring to FIGS. 5 and 6, the drive unit 70 outputs a voltage at certain intervals to apply a pulsed voltage E to the piezoelectric body 65. As shown in FIG. 6, the terminal voltage of the piezoelectric body 65 increases from its initial voltage EO with time during application T of a pulse of drive voltage and returns to the initial voltage EO immediately after application T of the pulse of drive voltage.

If the terminal voltage has changed with time as shown in FIG. 6 during application of a pulse of drive voltage, the control unit 80 that functions as the determination unit determines that a discharge operation is being performed normally. In this case, contact of the piezoelectric body 65 with the electrodes 66 and the mechanism of the piezoelectric element 69 are normal. The waveform of FIG. 6 is therefore a reference waveform for determining that a discharge operation is being performed normally.

If the terminal voltage has not changed with time as shown in FIG. 6 during application of a pulse of drive voltage, the control unit 80 determines that a discharge operation is not being performed normally (a discharge operation is being performed abnormally). In this case, the control unit 80 classifies such an abnormal discharge operation into two types based on the waveform of the terminal voltage during application of a pulse of drive voltage.

If the terminal voltage has not changed with time as shown in FIG. 6 but has changed with time as shown in FIG. 5 during application of a pulse of drive voltage, the control unit 80 determines that the abnormal discharge operation is due to an abnormality in a circuit in the pump 61 or an abnormality in a connection portion. For example, an abnormality in the circuit in the pump 61 or an abnormality in the connection portion is an abnormality due to defective contact between the electrode 66 and the piezoelectric body 65, defective connection between the electrode 66 and the terminal 68, defective connection between the terminal 68 and the drive unit 70, mechanical failure of the piezoelectric element 69, etc.

If the terminal voltage has neither the reference waveform of FIG. 6 nor the waveform of FIG. 5 during application of a pulse of drive voltage, the control unit 80 determines that the abnormal discharge operation is due to an abnormality other than an abnormality in the circuit in the pump 61. For example, an abnormality other than an abnormality in the circuit in the pump 61 is an abnormality due to a defect in a circuit that applies a voltage to the electrodes 66, an insufficiently charged battery, not shown, an abnormality in the electrode 66, etc. That is, an abnormality other than an abnormality in the circuit in the pump 61 is an abnormality in the control unit. As described above, if it is determined that the terminal voltage does not have the reference waveform of FIG. 6 during application of a pulse of drive voltage and thus determined that a discharge operation is being performed abnormally, whether or not the terminal voltage has the waveform of FIG. 5 is further determined. The cause of the abnormality can therefore be estimated.

The control unit 80 determines if the terminal voltage has increased with time during application of a pulse of drive voltage or not based on at least two terminal voltages measured at at least two measurement times during application of a pulse of drive voltage. For example, measurement times t1, t2 are set in advance in the control unit 80 (t1<t2). The measurement times t1, t2 are the points that divide the period of application T of a pulse of drive voltage into three approximately equal periods. Preferably, a measurement time t3 immediately after application T of a pulse of drive voltage is also set in the control unit 80 (t2<t3). The control unit 80 determines if terminal voltages E1, E2 measured at the measurement times t1, t2 by the measurement unit 13 have changed (increased) with time during the period from the measurement time t1 to the measurement time t2.

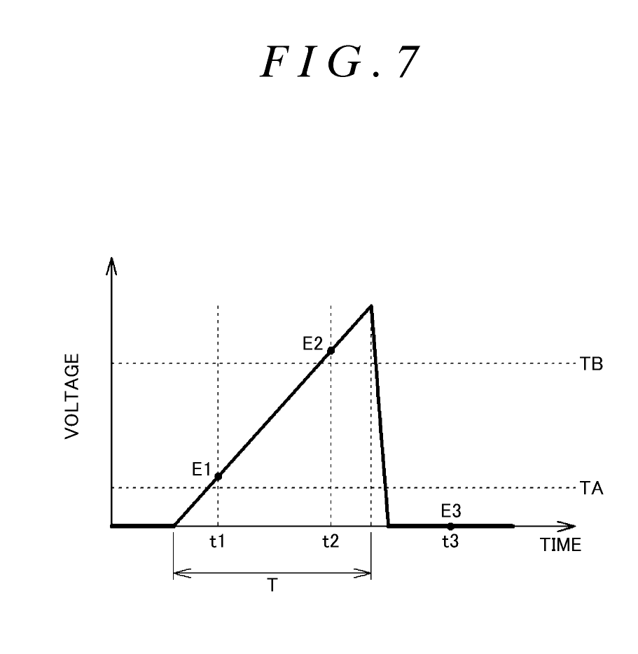

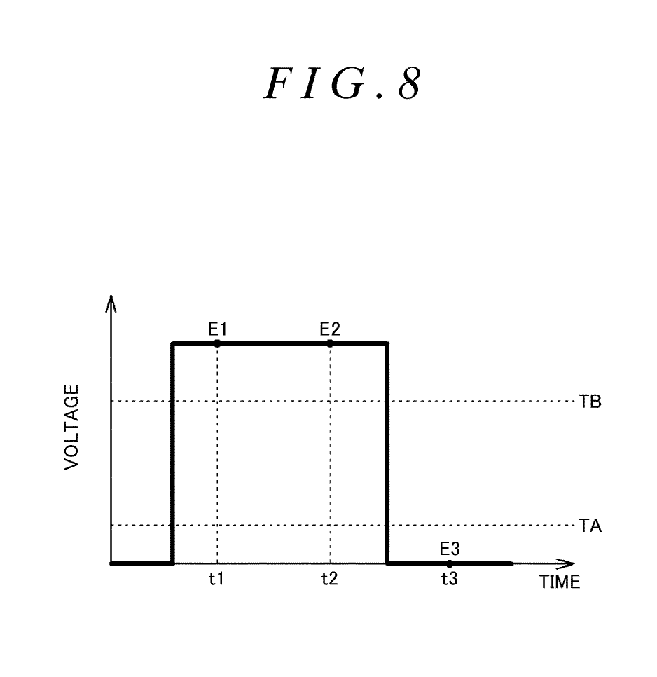

FIGS. 7 and 8 are waveform charts illustrating an example of a method for detecting an abnormal discharge operation by the abnormal discharge detection device. For example, the control unit 80 stores in advance threshold voltages TA, TB corresponding to the measurement times t1, t2, respectively. The threshold voltage TA is higher than the initial voltage E0 and is lower than the terminal voltage at the measurement time t1 in the reference waveform of FIG. 6. The threshold voltage TB is higher than the threshold voltage TA and is lower than the terminal voltage at the measurement time t2 in the reference waveform of FIG. 6. The control unit 80 compares the terminal voltages E1, E2 with the threshold voltages TA, TB to determine if the terminal voltages E1, E2 have increased with time during the period from the measurement time t1 to the measurement time t2.

FIG. 7 shows the relationship between the terminal voltage and the threshold voltages TA, TB in the case where the terminal voltage changes with time as shown in FIG. 6. Referring to FIG. 7, the terminal voltage E1 is higher than the threshold voltage TA and is lower than the threshold voltage TB. The terminal voltage E2 is higher than the threshold voltage TB. A terminal voltage E3 is equal to the initial voltage and is lower than the threshold voltage TA. Based on this relationship, in the case where the terminal voltage changes with time as shown in FIG. 6, the terminal voltages E1 to E3 satisfy the following expressions (1), (2). The expressions (1), (2) are herein referred to as the first condition.

E3≦TA≦E1 (1)

TB≦E2 (2)

FIG. 8 shows the relationship between the terminal voltage and the threshold voltages TA, TB in the case where the terminal voltage does not change with time but has a rectangular waveform as shown in FIG. 5. Referring to FIG. 8, the terminal voltage E1 and the terminal voltage E2 are approximately the same and are higher than the threshold voltage TB. The terminal voltage E3 is lower than the threshold voltage TA. Based on this relationship, in the case where the terminal voltage has a rectangular waveform as shown in FIG. 5, the terminal voltages E1 to E3 satisfy the following expressions (3) to (6). The expressions (3) to (6) are herein referred to as the second condition.

TB≦E1 (3)

TB≦E2 (4)

E3≦TA (5)

E1≈E2 (6)

The first and second conditions are an example of conditions that are used to detect an abnormal discharge operation. That is, the first and second conditions are an example of a method for determining if the terminal voltage has changed with time during application of a pulse of drive voltage. As described above, the control unit 80 uses threshold voltages stored in advance therein. Whether the terminal voltage has changed with time during application of a pulse of drive voltage can thus be determined by a simple process. The control unit 80 may not use the terminal voltage E3, namely the terminal voltage immediately after application of a pulse of drive voltage, in this method. This makes the determination process simpler.

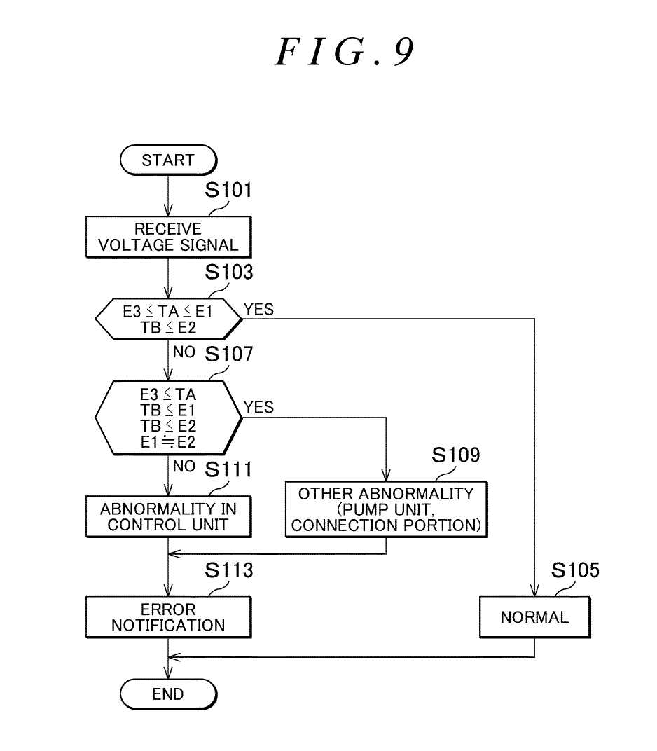

FIG. 9 is a flowchart showing an example of a detection operation of the abnormal discharge detection device. Referring to FIG. 9, the control unit 80 receives from the measurement unit 13 a voltage signal indicating a measured terminal voltage (step S101). The control unit 80 reads terminal voltages E1, E2, E3 from the voltage signal and compares the terminal voltages E1, E2, E3 with prestored threshold voltages TA, TB. If the terminal voltages E1 to E3 satisfy the above expressions (1), (2), namely if the terminal voltages E1 to E3 satisfy the first condition (Yes in step S103), the control unit 80 determines that a discharge operation is being performed normally (step S105).

If the terminal voltages E1 to E3 do not satisfy the above expressions (1), (2) but satisfy the above expressions (3) to (6), namely if the terminal voltages E1 to E3 satisfy the second condition (No in step S103 and Yes in step S107), the control unit 80 determines that there is an abnormality in the circuit in the pump 61 or the connection portion (step S109).

If the terminal voltages E1 to E3 do not satisfy the above expressions (1) to (6), namely if the terminal voltages E1 to E3 satisfy neither the first condition nor the second condition (No in step S103 and No in step S107), the control unit 80 determines that there is an abnormality in the control unit 80 (abnormality in a circuit in the drive unit 70 etc.) (step S111).

Preferably, the abnormal discharge detection device includes a transmission unit that outputs information. The transmission unit may be wireless communication or may be a light emitting diode (LED), a buzzer, etc. In the case where the abnormal discharge detection device includes the transmission unit, the control unit 80 is also connected to the transmission unit to control transmission of the transmission unit. If an abnormal discharge operation is detected in step S109 or step S111, the control unit 80 preferably controls the transmission unit to send an error notification (step S113). The error notification may be a notification that distinguishes between the determination result of step S109 and the determination result of step S111.

For example, the abnormal discharge detection device that detects an abnormal discharge operation in the fluid supply device, namely the oil supply unit 40, determines if a discharge operation is being performed normally or not based on whether or not the terminal voltage has changed with time during application of a pulse of drive voltage. This eliminates the need for a special device such as a sensor, whereby an abnormal discharge operation can be detected easily and accurately. This makes it possible to quickly deal with abnormal fluid supply.

The abnormal discharge detection device measures the terminal voltage at at least two measurement times t1, t2 during application of a pulse of drive voltage to determine if the terminal voltage has changed with time during application of a pulse of drive voltage or not based on at least two measured terminal voltages E1, E2. Whether a discharge operation is being performed normally or not can thus be easily determined.

The abnormal discharge detection device stores in advance the threshold voltages TA, TB for each measurement time and compares the each of at least two terminal voltages E1, E2 with a corresponding one of the threshold voltages TA, TB. The abnormal discharge detection device can thus easily and accurately determine if the terminal voltage has changed with time during application of a pulse of drive voltage. Accordingly, whether a discharge operation is being performed normally or not can be easily and accurately determined.

The first and second conditions are an example of conditions that are used to detect an abnormal discharge operation. That is, the first and second conditions are an example of a method for determining if the terminal voltage has changed with time during application of a pulse of drive voltage. As described above, the control unit 80 uses threshold voltages stored in advance therein. Whether the terminal voltage has changed with time during application of a pulse of drive voltage can thus be determined by a simple process. The control unit 80 may not use the terminal voltage E3, namely the terminal voltage immediately after application of a pulse of drive voltage, in this method. This makes the determination process simpler.

A first modification will be described below.

In another method for determining if the terminal voltage has changed with time during application of a pulse of drive voltage, the control unit 80 may compare the terminal voltages El, E2 to determine if the terminal voltages E1, E2 satisfy E1≦E2. Whether the terminal voltage has changed with time during application of a pulse of drive voltage or not can thus be determined by a simple process. Accordingly, whether a discharge operation is being performed normally or not can be easily determined.

A second modification will be described below.

In still another method for determining if the terminal voltage has changed with time during application of a pulse of drive voltage, the control unit 80 may store in advance a rate of change a in terminal voltage per unit time. The rate of change a corresponds to the rate of change (gradient) in terminal voltage which is shown in the reference waveform of FIG. 6. The control unit 80 determines if the amount of increase (E2-E1) from the terminal voltage E1 to the terminal voltage E2 is equal to the amount of increase α(t2-t1) obtained from the period (t2-t1) from the measurement time t1 to the measurement time t2 and the rate of change α. Whether the rate of increase in terminal voltage during application of a drive voltage is the same as the rate of increase of the reference waveform of FIG. 6 or not can thus be determined easily and accurately. That is, whether the terminal voltage has changed with time during application of a pulse of drive voltage or not can be determined easily and accurately. Accordingly, whether a discharge operation is being performed normally or not can be determined easily and accurately.

In the above description, the oil supply unit 40 mounted on the bearing device 100 is shown as an example of the fluid supply device. However, the fluid supply device is not limited to the oil supply unit that supplies oil to a bearing. For example, the fluid supply device may be any device that supplies fluid by using a piezoelectric body such as a piezo element, like an oil supply unit that supplies oil to a hydraulic motor, a gear, etc.

The embodiment disclosed herein is illustrative in all respects and should not be construed as restrictive. The scope of the present invention is defined by the claims rather than by the foregoing description, and the present invention is intended to include all changes that are made without departing from the spirit and scope of the claims.

According to the present invention, an abnormality in a pump mounted on a fluid supply device can be accurately detected.

What is claimed is:

1. An abnormal discharge detection device that detects an abnormal fluid discharge operation in a fluid supply device, the fluid supply device including a drive unit that outputs a pulsed drive voltage, a piezoelectric element that is repeatedly deformed when the pulsed drive voltage is applied, and a storage unit that stores therein fluid to be supplied, and the fluid supply device discharging the fluid from the storage unit as volume of the storage unit decreases with the deformation of the piezoelectric element, the abnormal discharge detection device comprising:
a measurement unit that measures a terminal voltage of the piezoelectric element; and
a determination unit that determines if the discharge operation is being performed normally or not based on whether or not the terminal voltage measured with the measurement unit has changed with time during application of a pulse of the drive voltage.

2. The abnormal discharge detection device according to claim 1, wherein
the measurement unit measures the terminal voltage at at least two measurement times during application of the pulse of the drive voltage, and
the determination unit determines if the discharge operation is being performed normally or not by determining if the terminal voltage has changed with time during application of the pulse of the drive voltage or not based on at least two terminal voltages measured at the at least two measurement times.

3. The abnormal discharge detection device according to claim 2, wherein
the determination unit determines if the discharge operation is being performed normally or not by comparing a first terminal voltage, which is a value measured at a first measurement time during application of the pulse of the drive voltage, with a second terminal voltage, which is a value measured at a second measurement time after the first measurement time, and determining if the second terminal voltage is larger than the first terminal voltage.

4. The abnormal discharge detection device according to claim 3, wherein
the determination unit stores in advance a rate of change in terminal voltage per unit time during application of a pulse of the drive voltage, and determines if the discharge operation is being performed normally or not by determining if an amount of increase from the first terminal voltage to the second terminal voltage is equal to an amount of increase obtained from a period from the first measurement time to the second measurement time and the rate of change.

5. The abnormal discharge detection device according to claim 2, wherein
the determination unit stores in advance threshold terminal voltages for each of the measurement times, and determines if the discharge operation is being performed normally or not by comparing each of the at least two terminal voltages with a corresponding one of the threshold terminal voltages.

6. The abnormal discharge detection device according to claim 1, wherein
the measurement unit further measures a terminal voltage of the piezoelectric element immediately after application of the drive voltage is stopped, and
the determination unit further determines if the discharge operation is being performed normally or not based on whether or not the terminal voltage measured with the measurement unit immediately after application of the drive voltage is stopped is equal to the drive voltage.

7. The abnormal discharge detection device according to claim 1, wherein
the determination unit determines that the discharge operation is being performed abnormally, when the terminal voltage measured with the measurement unit during application of the pulse of the drive voltage is equal to the drive voltage.

8. A method for detecting an abnormal fluid discharge operation in a fluid supply device, the fluid supply device including a drive unit that outputs a pulsed drive voltage, a piezoelectric element that is repeatedly deformed when the pulsed drive voltage is applied, and a storage unit that stores therein fluid to be supplied, and the fluid supply device discharging the fluid from the storage unit as volume of the storage unit decreases with the deformation of the piezoelectric element, the method comprising:
measuring a terminal voltage of the piezoelectric element during application of a pulse of the drive voltage; and
determining if the discharge operation is being performed normally or not based on whether or not the measured terminal voltage has changed with time.
